(19) United States
(12) Patent Application Publication
(10) Pub. No.: US 2023/0059286 A1
(43) Pub. Date: Feb. 23, 2023

(54) AUTOMATIC FEEDING AND SCANNING DEVICE

(71) Applicant: KINPO ELECTRONICS, INC., NEW TAIPEI CITY (TW)

(72) Inventors: Zhen-Yang MA, NEW TAIPEI CITY (TW); Tzu-Cheng CHANG, NEW TAIPEI CITY (TW); Po-Chih CHANG, NEW TAIPEI CITY (TW)

(21) Appl. No.: 17/491,399

(22) Filed: Sep. 30, 2021

(30) Foreign Application Priority Data
Aug. 23, 2021 (CN) 202121985156.1

(51) Int. Cl. G03G 15/00; B65H 1/04

(52) U.S. Cl. CPC G03G 15/6508; B65H 1/04; B65H 2301/5115; B65H 2404/561

(57) ABSTRACT

This disclosure is directed to an automatic feeding and scanning device having a scanning module, a paper feeding module and a cleaning module. The scanning module has a carrying platen, a scanning platen, and a scanner, the carrying platen and the scanning platen are light transmissive plates, two surfaces of the scanning platen are a bottom surface and a top surface opposite to the bottom surface, the scanner is arranged corresponding to the bottom surface of the scanning platen. The cleaning module has a brush and an actuating assembly connected to the brush and driving the brush. The brush is arranged corresponding to the top surface of the scanning platen, the actuating assembly drives the brush to scrape the top surface of the scanning platen.

### BACKGROUND OF THE DISCLOSURE

### Technical Field

This disclosure is directed to an automatic feeding and scanning device of a copy machine, and in particular to an automatic feeding and scanning device having a cleaning module.

### Description of Related Art

A related automatic feeding and scanning device of a copy machine has a scanning module and a paper feeding module. The scanning module has a scanning platen assembled by one or more glass plates and a scanner arranged under the scanning platen. The paper feeding module is stacked on the scanning module, the paper feeding module can continuously feed pages through a specific region on the scanning platen. When the pages pass the region, the scanner is held at this region so as to scan the respective passing pages. The page can be put on the scanning platen and pressed by the paper feeding module, and the single page can be scanned by moving the scanner.

The toners used for printing by the copy machine or fibers of the papers may adhere to the scanning platen, thereby the scanning performance is reduced. A user generally needs to lift the paper feeding module before scanning a single page, and the dust on the scanning platen may be noted and cleaned. However, it is not necessary to lift the paper feeding module for continuous scanning by the paper feeding module, thereby the dust on the scanning platen is not easy to be noted.

In view of the above drawbacks, the inventor proposes this disclosure based on his expert knowledge and elaborate researches in order to solve the problems of related art.

### SUMMARY OF THE DISCLOSURE

This disclosure is directed to an automatic feeding and scanning device having a cleaning module.

One of the exemplary embodiments, the automatic feeding and scanning device has a scanning module, a paper feeding module and a cleaning module. The scanning module has a carrying platen, a scanning platen, and a scanner, the carrying platen and the scanning platen are light transmissive plates, two surfaces of the scanning platen are a bottom surface and a top surface opposite to the bottom surface, the scanner is arranged corresponding to the bottom surface of the scanning platen, and the scanner is configured to selectively stay at the bottom surface of the scanning platen or move along the carrying platen. The paper feeding module is stacked on the scanning module, a paper feeding path is defined in the paper feeding module, a scanning window communicating with a side of the paper feeding path is defined on the paper feeding module, and the scanning window is covered by the top surface of the scanning platen. The cleaning module has a brush and an actuating assembly connected to the brush and configured to drive the brush. The brush is arranged corresponding to the top surface of the scanning platen, the actuating assembly drives the brush to scrape the top surface of the scanning platen.

According to the automatic feeding and scanning device of this disclosure, a paper holder is arranged pivotally in the paper feeding module, the paper holder is arranged corresponding the scanning window, the brush is attached on a side of the paper holder and the actuating assembly is connected with the paper holder so as to move the brush to contact the top surface of the scanning platen by driving the paper holder to rotate.

According to the automatic feeding and scanning device of this disclosure, the cleaning module further has a driving belt extended parallelly with the scanning platen, the brush is arranged on the driving belt and contacts the top surface of the scanning platen, and the actuating assembly is engaged with the driving belt. The actuating assembly has an actuating motor linked with the driving belt.

According to the automatic feeding and scanning device of this disclosure, the cleaning module further has a driving belt extended parallelly with the scanning platen, the brush is arranged on the driving belt and contacts the top surface of the scanning platen, and the actuating assembly is connected with the driving belt. The actuating assembly has a handle connected with the driving belt, and at least a part of the handle is exposed from the paper feeding module or the scanning module. The actuating assembly has a track extended parallelly with the scanning platen, the handle is inserted in the track so as to move along the track.

According to the automatic feeding and scanning device of this disclosure, the actuating assembly may be arranged in the scanning module. The actuating assembly alternatively may be arranged in the paper feeding module.

According to the automatic feeding and scanning device of this disclosure, a guiding slope is arranged obliquely on the top surface of the scanning platen and located between the scanning platen and the paper feeding path. The scanning platen and the carrying platen are formed in one piece. The paper feeding module is pivoted to the scanning module.

According to the automatic feeding and scanning device of this disclosure, the scanning platen may be extended from a side of the carrying platen. The scanning platen alternatively may overlap a portion of the carrying platen.

This disclosure is directed to an automatic feeding and scanning device having a cleaning module. Accordingly, it is easy to clean the scanning platen during an automatic feeding and scanning operation even the paper feeding module is not lifted from the scanning platen.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is an exploded view showing an automatic feeding and scanning device according to the first embodiment of this disclosure.

FIGS. 2 to 3 are cross-sectional views of the automatic feeding and scanning device according to the first embodiment of this disclosure.

FIG. 4 is an exploded view showing an automatic feeding and scanning device according to the second embodiment of this disclosure.

FIG. 5 is an exploded view showing a variation of the automatic feeding and scanning device according to the second embodiment of this disclosure.

FIG. 6 is an exploded view showing an automatic feeding and scanning device according to the third embodiment of this disclosure.

FIG. 7 is a perspective view showing an automatic feeding and scanning device according to the third embodiment of this disclosure.

### DETAILED DESCRIPTION OF THE EMBODIMENTS

The technical contents of this disclosure will become apparent with the detailed description of embodiments accompanied with the illustration of related drawings as follows. It is intended that the embodiments and drawings disclosed herein are to be considered illustrative rather than restrictive.

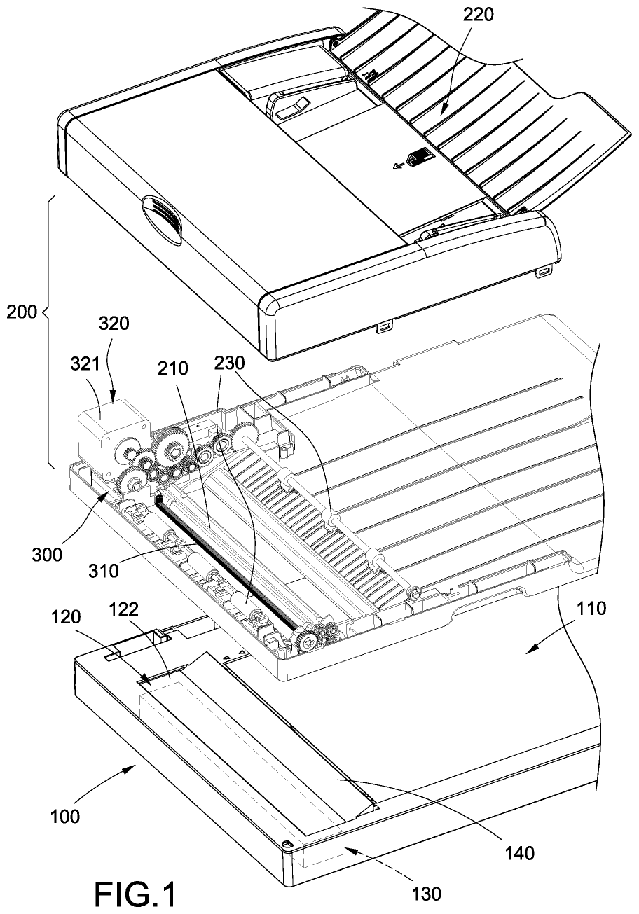

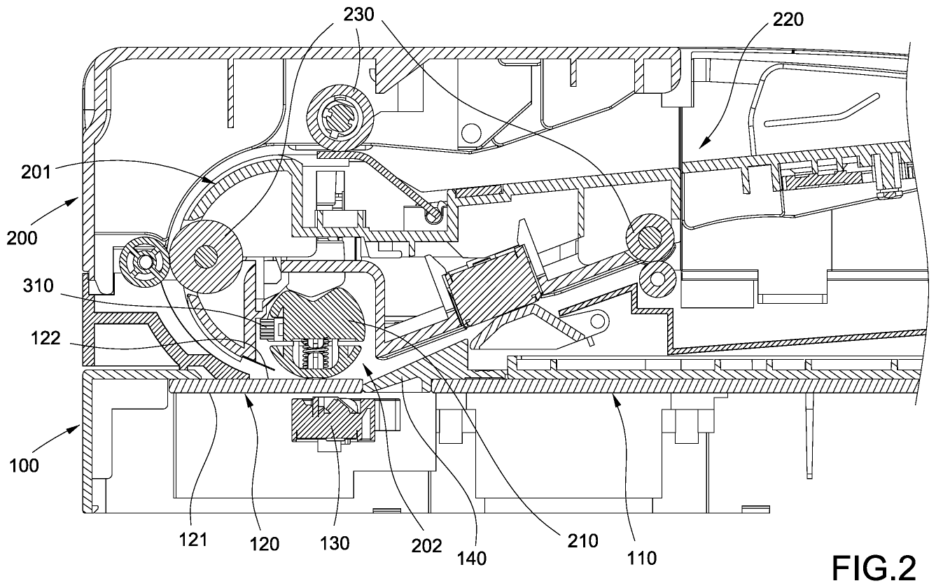

According to the first embodiment of this disclosure shown in FIGS. 1 and 2, an automatic feeding and scanning device at least having a scanning module 100, a paper feeding module 200 and a cleaning module 300 is provided.

The scanning module 100 has a carrying platen 110, a scanning platen 120 and a scanner 130, the carrying platen 110 is a light transmissive plate disposed in a horizontal configuration, the scanning platen 120 is also a light transmissive plate disposed in a horizontal configuration and extended from a side of a periphery of the carrying platen 110. For example, the light transmissive plate may be a transparent glass plate or a transparent plastic plate. According to this embodiment, the scanning platen 120 and the carrying platen 110 are two light transmissive plates. However, alternatively, the scanning platen 120 and the carrying platen 110 may be formed in one piece of a single light transmissive plate. Moreover, the scanning platen 120 may overlap (include) a portion of the carrying platen 110, namely a region on the single light transmissive plate is used for the carrying platen 110 and a part in that region is used for the scanning platen 120.

Two surfaces of the scanning platen 120 are a bottom surface 121 and a top surface 122 opposite to the bottom surface 121, the scanner 130 is arranged under the scanning platen 120 and may move horizontally, the scanner 130 may be initially located at a position corresponding to the bottom surface 121 of the scanning platen 120, and the scanner 130 may selectively stay at the bottom surface 121 of the scanning platen 120 or move to underside of the carrying platen 110 and move along the carrying platen 110. In general, the scanner 130 may be connected to a belt and driven by a motor engaged with the belt via a gear group. A guiding slope structure 140 may be arranged at a side of the scanning platen 120, the carrying platen 110 in this embodiment is arranged adjacent to the scanning platen 120, and the guiding slope structure 140 is located between the scanning platen 120 and the carrying platen 110.

The paper feeding module 200 is stacked on the scanning module 100, and the paper feeding module 200 is pivoted to the scanning module 100. A paper feeding path 201 is formed in the paper feeding module 200, a scanning window 202 communicating with a side of the paper feeding path 201 is formed on the paper feeding module 200, and the scanning window 202 is arranged at a position corresponding to the top surface 122 of the scanning platen 120 so that the scanning window 202 is covered by the top surface 122 of the scanning platen 120. The paper feeding module 200 is used for continuous feeding of a plurality of document pages through the paper feeding path 201. Specifically, the paper feeding module 200 has a tray 220 for containing the plurality of document pages, and the paper feeding module 200 is provided with a plurality of wheel 230 therein for transporting the document pages from the tray 220 through the paper feeding path 201. The scanner 130 may be hold at the scanning platen 120 so as to scan the respective document pages passing the scanning window 202. A paper holder 210 is arranged in the paper feeding module 200, and the paper holder 210 is arranged corresponding to the scanning window 202. During a scanning operation to the respective document pages passing the paper feeding path 201, the paper feeding module 200 press the document page passing the scanning window 202 onto the scanning platen 120 by the paper holder 210. The guiding slope structure 140 is arranged at a side of the scanning window 202 and extended along the side so as to be perpendicular to an extending direction of the paper feeding path 201. Therefore, the document pages passing the scanning window 202 may be guided and hold in the paper feeding path 201. According to this embodiment, the guiding slope structure 140 is of an elongated shape with a cross section of a right triangle, the guiding slope structure 140 is arranged on the top surface 122 of the scanning platen 120, the guiding slope structure 140 is attached on a side of the scanning window 202. The guiding slope of the guiding slope 140 is defined by the hypotenuse of the right triangle. Therefore, the guiding slope of the guiding slope 140 is inclined corresponding to the top surface 122 of the scanning platen 120 so as to be located between the top surface 122 of the scanning platen 120 and the paper feeding path 201. The document page passing the scanning window 202 is pushed out from the scanning window 202 by the paper holder 210 to attach on the scanning platen 120 and further guided by the guiding slope structure 140 to return into the paper feeding path 201.

Specifically, the carrying platen 110 is used for carrying the document page, and the scanner 130 may move along the carrying platen 110 to scan the document page. During the scanning operation to the document page on the carrying platen 110, the paper feeding module 200 may press on the document page onto the carrying platen 110 by a weight thereof.

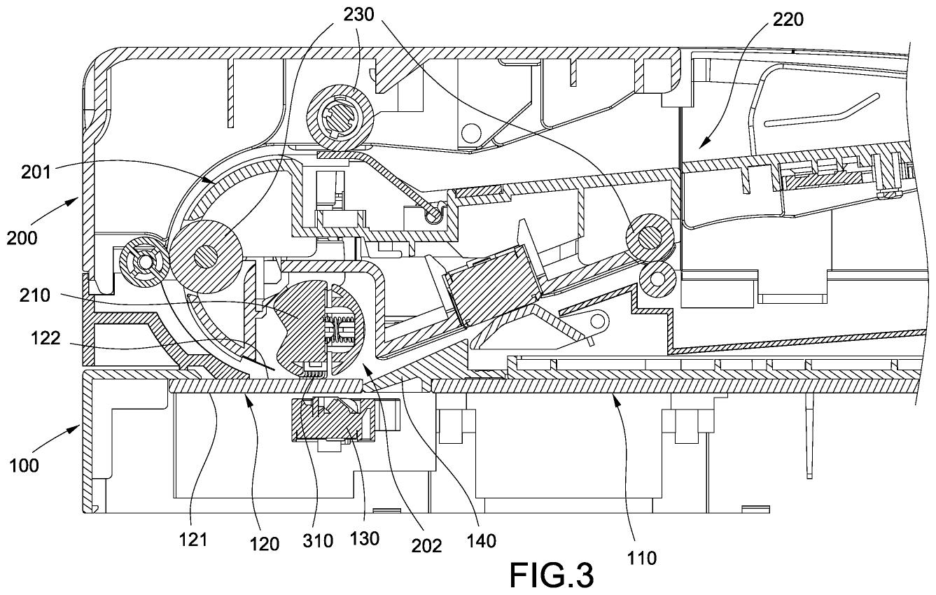

According to this embodiment shown in FIGS. 1 to 3, the cleaning module 300 has a brush 310 and an actuating assembly 320 connected to the brush 310 and driving the brush 310, the brush 310 is arranged corresponding to the top surface 122 of the scanning platen 120, and the actuating assembly 320 may drive the brush 310 to scrape the top surface 122 of the scanning platen 120. According to FIGS. 2 and 3, specifically, the paper holder 210 is arranged pivotally in the paper feeding module 200 and is rotatable. The brush 310 is arranged on a side of the paper holder 210, the actuating assembly 320 is connected to the paper holder 210 to move the brush 310 to contact the top surface 122 of the scanning platen 120 by driving the paper holder 210 to rotate. The actuating assembly 320 may have an actuating motor 321, and the actuating motor 321 may be engaged with the paper holder 210 directly or linked with the paper holder 210 via gears so as to rotate the paper holder 210. Moreover, the actuating motor 321 may also be used for driving the wheel 230 or the scanner 130.

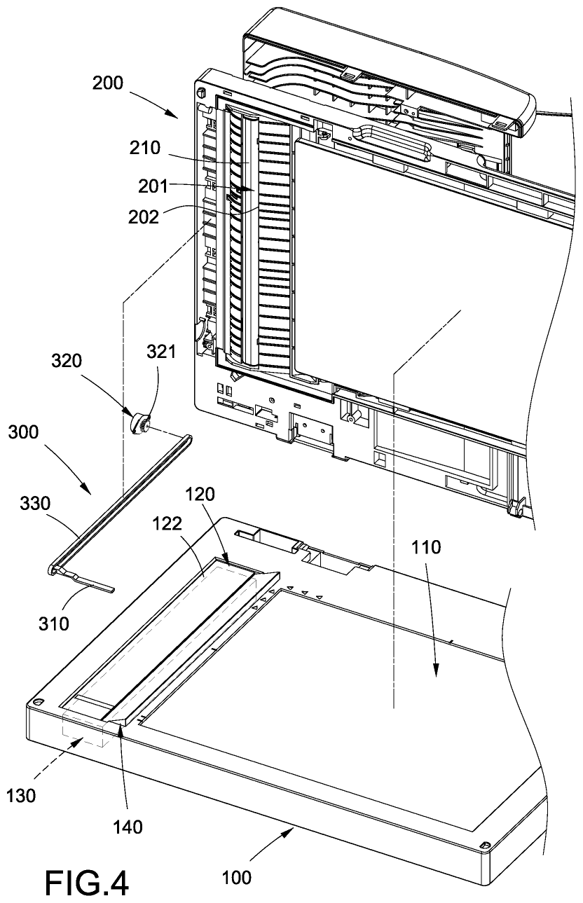

According to the second embodiment of this disclosure shown in FIG. 4, an automatic feeding and scanning device at least having a scanning module 100, a paper feeding module 200 and a cleaning module 300 is provided. The scanning module 100 and the paper feeding module 200 are similar to the aforementioned first embodiment and here the description thereof is omitted for brevity. The differences between this embodiment and the first embodiment are described below.

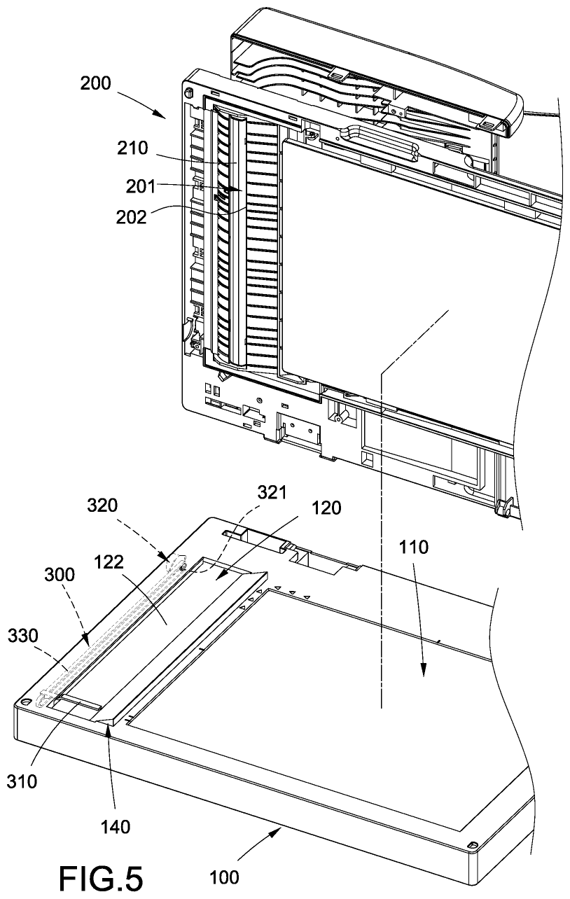

According to this embodiment shown in FIGS. 1 to 3, the cleaning module 300 has a brush 310, a driving belt 330 and an actuating assembly 320 connected to the brush 310 and driving the brush 310, the brush 310 is arranged on the driving belt 330 and contacts the top surface 122 of the scanning platen 120. The actuating assembly 320 is engaged with the driving belt 330. The actuating assembly 320 drives the driving belt 330 to move the brush 310 along the scanning platen 120 to scrape the top surface 122 of the scanning platen 120. According to this embodiment, the driving belt 330 may be a belt or a chain, and the type of the driving belt 330 is not limited to the embodiment. According to this embodiment, the actuating assembly 320 is an actuating motor 321 linked with the driving belt 330, and the actuating motor 321 may be engaged with the driving belt 330 via gears. The position of the actuating assembly 320 is not limited to the embodiment, for example, the actuating assembly 320 may be arranged in the paper feeding module 200 as shown in FIG. 4. Alternatively, the actuating assembly 320 may be arranged in the scanning module 100 as shown in FIG. 5.

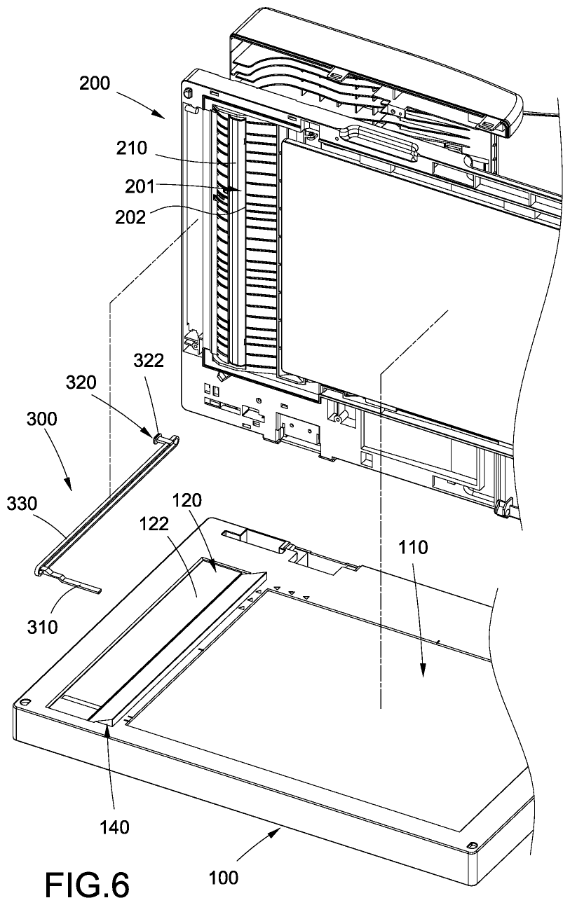

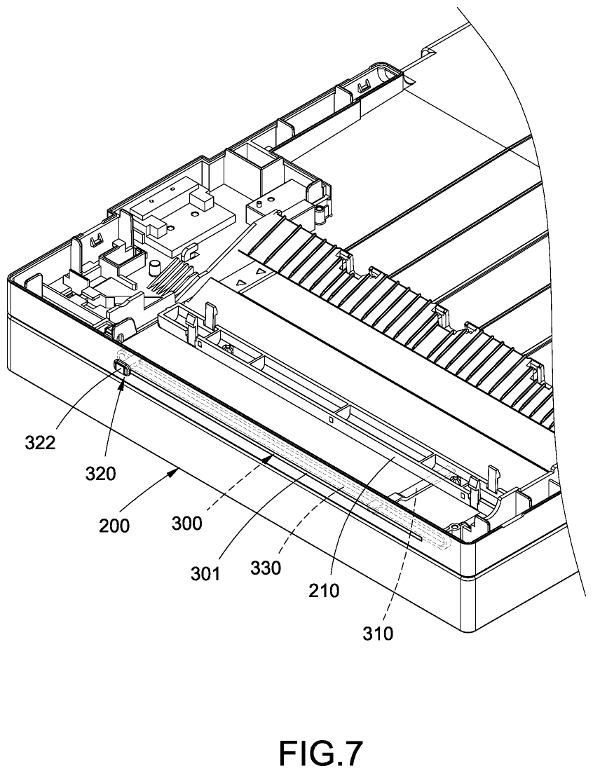

According to the third embodiment of this disclosure shown in FIGS. 6 and 7, an automatic feeding and scanning device at least having a scanning module 100, a paper feeding module 200 and a cleaning module 300 is provided. The scanning module 100 and the paper feeding module 200 are similar to the aforementioned first embodiment and here is omitted for brevity. The differences between this embodiment and the first embodiment are described below.

According to this embodiment, the cleaning module 300 has a brush 310, a driving belt 330 and an actuating assembly 320. The driving belt 330 is extended parallelly with the scanning platen 120, the brush 310 is arranged on the driving belt 330 and contacts the top surface 122 of the scanning platen 120. The actuating assembly 320 is connected with the driving belt 330. According to this embodiment, the actuating assembly 320 has a handle 322 connected to the driving belt 330, at least a portion of the handle 322 is exposed from the paper feeding module 200 according to this embodiment, thereby a user may pull the driving belt 330 to move the brush 310. On the other hand, the handle 322 may alternatively exposed from the scanning module 100, and a user may pull the driving belt 330 to move the brush 310. The driving belt 330 is driven by the actuating assembly 320, and the brush 310 is driven to move along the scanning platen 120 to scrape the top surface 122 of the scanning platen 120. Furthermore, the actuating assembly 320 has a track 301, the track 301 is extended parallelly with the scanning platen 120, the handle 322 is inserted in the track 301 and slidable along the track 301. According to this embodiment, the driving belt 330 may be a belt or a chain, and the type of the driving belt 330 is not limited to the embodiment. According to this embodiment, the actuating assembly 320 is arranged in the paper feeding module 200 and the track 301 is a slot on the paper feeding module 200, but the track 301 is not limited to this embodiment. Moreover, according to the arrangement of the second embodiment shown in FIG. 5, the actuating assembly 320 may be arranged in the scanning module 100 in this embodiment, and the track 301 may be arranged on a housing of the scanning module 100.

This disclosure is directed to an automatic feeding and scanning device having a cleaning module 300 for cleaning the scanning platen 120. Accordingly, it is easy to clean the scanning platen 120 during an automatic feeding and scanning operation even the paper feeding module 200 is not lifted from the scanning platen 120. The dust on the top surface 122 of the scanning platen 120 may be scraped out of a scanning region temporarily by the brush 310 of the cleaning module 300 and further removed when the paper feeding module 200 is lifted later.

While this disclosure has been described by means of specific embodiments, numerous modifications and variations could be made thereto by those skilled in the art without departing from the scope and spirit of this disclosure set forth in the claims.

What is claimed is:

1. An automatic feeding and scanning device, comprising:
a scanning module, comprising a carrying platen, a scanning platen and a scanner, the carrying platen and the scanning platen respectively comprising a light transmissive plate, two surfaces of the scanning platen being a bottom surface and a top surface opposite to the bottom surface, the scanner arranged corresponding to the bottom surface of the scanning platen, and the scanner being configured to selectively stay at the bottom surface of the scanning platen or move along the carrying platen;
a paper feeding module, stacked on the scanning module, and comprising a paper feeding path disposed therein and a scanning window communicating with a side of the paper feeding path, and the scanning window covered by the top surface of the scanning platen; and
a cleaning module, comprising a brush and an actuating assembly connected to the brush and configured to drive the brush,
wherein the brush is arranged corresponding to the top surface of the scanning platen, the actuating assembly drives the brush to scrape the top surface of the scanning platen.

2. The automatic feeding and scanning device according to claim 1, wherein a paper holder is arranged pivotally in the paper feeding module, the paper holder is arranged corresponding the scanning window, the brush is attached on a side of the paper holder and the actuating assembly is connected with the paper holder to move the brush to contact the top surface of the scanning platen by driving the paper holder to rotate.

3. The automatic feeding and scanning device according to claim 1, wherein the cleaning module further comprises a driving belt extended parallelly with the scanning platen, the brush is arranged on the driving belt and contacts the top surface of the scanning platen, and the actuating assembly is engaged with the driving belt.

4. The automatic feeding and scanning device according to claim 3, wherein the actuating assembly comprises an actuating motor linked with the driving belt.

5. The automatic feeding and scanning device according to claim 1, wherein the cleaning module further comprises a driving belt extended parallelly with the scanning platen, the brush is arranged on the driving belt and contacts the top surface of the scanning platen, and the actuating assembly is connected with the driving belt.

6. The automatic feeding and scanning device according to claim 5, wherein the actuating assembly comprises a handle connected with the driving belt, and at least a part of the handle is exposed from the paper feeding module or the scanning module.

7. The automatic feeding and scanning device according to claim 6, wherein the actuating assembly comprises a track extended parallelly with the scanning platen, the handle is inserted in the track to slide along the track.

8. The automatic feeding and scanning device according to claim 1, wherein the actuating assembly is arranged in the scanning module.

9. The automatic feeding and scanning device according to claim 1, wherein the actuating assembly is arranged in the paper feeding module.

10. The automatic feeding and scanning device according to claim 1, wherein a guiding slope is arranged on a side of the scanning platen, the guiding slope is arranged obliquely on the top surface of the scanning platen and located between the scanning platen and the paper feeding path.

11. The automatic feeding and scanning device according to claim 1, wherein the scanning platen and the carrying platen are formed in one piece.

12. The automatic feeding and scanning device according to claim 1, wherein the paper feeding module is connected pivotally with the scanning module.

13. The automatic feeding and scanning device according to claim 1, wherein the scanning platen is extended from a side of the carrying platen.

14. The automatic feeding and scanning device according to claim 1, wherein the scanning platen is configured to overlap a portion of the carrying platen.
